(19) United States
(12) Patent Application Publication
(10) Pub. No.: US 2011/0161415 A1
(43) Pub. Date: Jun. 30, 2011

(54) Presence Information Management

(75) Inventor: Christian Olrog, Stockholm (SE)

(73) Assignee: TELEFONAKTIEBOLAGET L M ERICSSON (PUBL), Stockholm (SE)

(21) Appl. No.: 13/063,655

(22) PCT Filed: Sep. 23, 2008
(86) PCT No.: PCT/SE2008/000527

§ 371 Date: Mar. 11, 2011

(51) Int. Cl. G06F 15/16

(52) U.S. Cl. 709/203

(57) ABSTRACT

A method and system for managing presence information for a presentity (100) includes or comprises means for: sending (130) a presence document (120) from a client (114) to a presence server (112), the document (120) comprising a first time interval (τ1) indicating a first presence state associated with the presentity (100) and comprising a second time interval (τ2) indicating a second presence state associated with the presentity (100), sending (132) the presence document (120) from the presence server (112) to a watching client (116), and updating (134), at the watching client (116), the representation of the first presence state and the representation of the second presence state.

### TECHNICAL FIELD

The present invention relates to a method and a system for managing presence information of a presentity. The invention also relates to a server, client, watcher and computer readable medium of the system.

### BACKGROUND ART

In computer and telecommunications networks, presence information is a status indicator that conveys ability and willingness of a potential communication partner, for example a user to communicate. A user's client provides presence information, i.e. presence state, via a network connection to a presence service usually running on a presence server. The presence information is stored in what constitutes the user's personal availability record, which is called a presentity and can be made available for distribution to other users (watchers) to convey his availability for communication.

In this context a “presentity” is an entity described by presence information. Presentity usually refers to a human but can also refer to a group of humans, for example a collection of customer service agents in a call center, or can refer to an object such as a meeting-room, a projector, a roll-up poster etc. In this case presence information may describe availability and willingness of a human to communicate via set of communication services, or it may describe an objects availability for a user. Accordingly, users of, for example, an instant messaging service such as ICQ or MSN Messenger are presentities and their presence information is ICQ user status (online, offline, away, etc.).

Today presence information data formats (PIDFs) exists which define basic XML formats for presenting presence information for a presentity. Moreover, the PIDFs provide for adding a timed status extension (<timed-status> element) that allows a presentity to declare its status (available, away, printing, occupied etc.) for a time interval fully in the future or in the past.

Server support for timed status extension may result in heavy traffic, e.g. when everyone goes to lunch at noon a huge amount of presence updates often need to be sent out from the presence server to each watcher. For example, since existing timed status (presence) extensions may not cover current time, when a whole organization marks lunch at 12:00 in their calendar, the presence server must send out presence updates for all employees (watchers) at 12:00 sharp.

### SUMMARY OF THE INVENTION

In view of the foregoing, it is an object of the present invention to provide an improvement of the above techniques and prior art. More particularly, it is an object to provide a reduction of the work load of a presence server that supports timed status extension.

Hence a method of managing presence information for a presentity is provided, the method comprising the steps of: sending a presence document from a client to a presence server, the document comprising a first time interval indicating a first presence state associated with the presentity and comprising a second time interval indicating a second presence state associated with the presentity; sending the presence document from the presence server to a watching client; and updating, at the watching client, the representation of the first presence state and the representation of the second presence state.

Here “presence document” means data having a Presence Information Data Format (PIDF), preferably defined in a basic XML format, for presenting presence information for a presentity. Accordingly, the invention extends the PIDF, by adding a second timed status extension (<timed-status-2> element) which allows a presentity to declare its status for two time intervals fully in the future or the past. Of course, additional timed status extensions may be added for declaring the status of a plurality of time intervals, and the invention is not limited to two timed status extensions.

It should be noted that “updating the representation of a presence state” means updating of how the presence state is displayed or stored at the watcher.

The inventive method is advantageous in that it is not necessary to send out presence updates at the very moment a presence status change, since several (i.e. more than one) updates may be sent out to the watchers at a time before the status change. This reduces the work load of the presence server, in particular peak loads.

The step of sending the presence document to the watching client may comprise sending the presence document to the watching client before time falls (local real) within any of the time intervals, which further reduces the general work load as well as a peak work load of the presence server.

The step of updating the representation of the presence states may comprise updating the representation of any of the first and the second presence state before time (local real) falls within the time interval of the presence state to be updated, for enabling a watcher to verify the presence state as well as have early information of the presence of the presentity.

The first time interval may be different from the second time interval, which is quite useful in order to utilize the full advantages of the invention.

The method may further comprise the step of scheduling sending of a plurality of presence documents from the presence server, in dependence of the amount of presence documents to be sent by the presence server. By using scheduling, it is possible to more effectively control the work load of the presence server. Typically time-distribution may be used as the scheduling method.

The method may further comprise the step of sending, from the watching client to the presence server, a message indicative of the watching clients capability of updating the representation of the first and second presence states by retrieving said presence states from the presence document. This enables the server to communicate a proper presence document to each client.

The method may further comprise the step of sending, from the presence server to a watching client not capable of updating the representation of the first and second presence states by retrieving said presence states from the presence document, a presence document comprising only one of said time intervals and corresponding presence state. This enables the server to communicate presence of a presentity to watchers not capable of receiving data having the inventive PIDF-format.

The method may further comprise defining a time value indicating when the presence document may be sent from the presence server to the watching client, which is advantageous in that it is more easy to ensure that the presence document is sent in time while still it must not immediately be sent upon receipt at the presence server.

The presence document may be represented by a data structure comprising at least two entities representing the first time interval and the second time interval, for facilitating a straight-forward implementation of the invention.

According to another aspect of the invention, a system is provided for managing presence information for a presentity, the system being configured to: send a presence document from a client to a presence server, the document comprising a first time interval indicating a first presence state associated with the presentity and comprising a second time interval indicating a second presence state associated with the presentity; send the presence document from the presence server to a watching client; and update, at the watching client, the representation of the first presence state and the representation of the second presence state.

According to yet another aspect of the invention, a presence server is provided for managing presence information for a presentity, the presence server being configured to: receive a presence document from a client, the document comprising a first time interval indicating a first presence state associated with the presentity and comprising a second time interval indicating a second presence state associated with the presentity; and send the presence document to a watching client, for allowing the watching client to update the representation of the first presence state and the representation of the second presence state.

According to a further aspect of the invention, a presentity client is provided for managing presence information for a presentity, the client being configured to: send a presence document to a presence server, the document comprising a first time interval indicating a first presence state associated with the presentity and comprising a second time interval indicating a second presence state associated with the presentity, for allowing the presence server to send the presence document to a watching client and thereby allow the watching client to update its representation of the first presence state and the representation of the second presence state.

According to another aspect of the invention a watcher is provided for displaying presence information for a presentity, the watcher being configured to: receive a presence document from a presence server, the presence document being previously sent from a client to the presence server, the document comprising a first time interval indicating a first presence state associated with the presentity and comprising a second time interval indicating a second presence state associated with the presentity; and update the representation of a first presence state and the representation of a second presence state, such that the presence states may be viewed at the watcher.

According to still another aspect of the invention a computer readable medium is provided, having stored thereon software instructions for performing the method described above, when executed in a presence system.

The inventive system, presence server, presentity client and watcher client may each comprise and/or be configured to execute any of the respectively associated features described above in connection with the inventive method, and has corresponding advantages.

### BRIEF DESCRIPTION OF THE DRAWINGS

Embodiments of the present invention will now be described, by way of example, with reference to the accompanying schematic drawings, in which

FIG. 1 illustrates the invention,

FIG. 2 illustrates a data structure implementing the invention, and

FIG. 3 shows hardware components of the invention.

### DETAILED DESCRIPTION OF PREFERRED EMBODIMENTS OF THE INVENTION

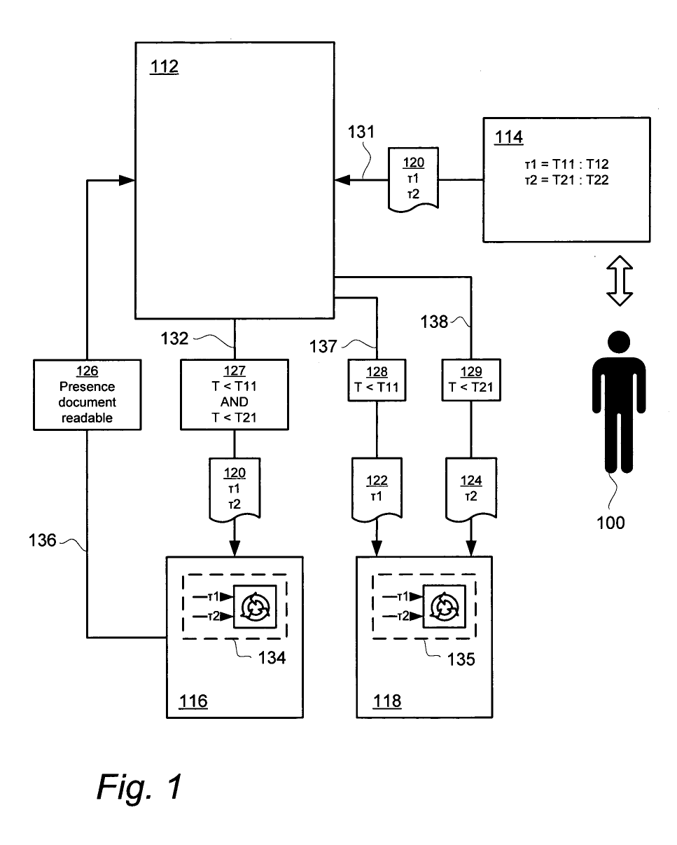

With reference to FIG. 1 the inventive method and system are illustrated, where a client 114 of a presentity 100 is connected to a presence server 112. A first watcher 116, i.e. a first client that subscribes to presence information of the presentity 100, and a second watcher 118, i.e. a second client that subscribes to presence information of the presentity 100 are connected to the presence server 112.

The presence server 112, presentity client 114 and watchers 116, 118 mutually communicate and operate in a conventional, known manner. In particular, the system implements the Common Profile for Presence (CPP) Presence Information Data Format (PIDF) as a common presence data format for CPP-compliant presence protocols, as well as implements Timed Presence Extensions to the PIDF to indicate status information for past and future time intervals, in accordance with the Request for Comment no. 3863 (RFC 3863) and the Request for Comment no. 4481 (RFC 4481) issued by the Network Working Group. On Sep. 22, 2008 RFC 3863 was available on http://www.ietf.org/rfc/rfc3863.txt and RFC 4481 was available on http://www.ietf.org/rfc/rfc4481.txt.

Both RFC 3863 and RFC 4481 are in this patent-application incorporated by reference.

Hence, the implemented PIDF has a timed status extension (<timed-status> element) that allows a presentity to declare its status for a time interval fully in the future or the past. This <timed-status> element comprises a time interval τ1 which is defined by the time values T11 and T12. The implemented PIDF has, according to the invention, a second timed status extension (<timed-status-2> element) that allows a presentity to declare its status for a time interval fully in the future, in the past or in the present time. This second time status element comprises a second time interval τ2 which is defined by the time values T21 and T22.

The second time status element (<timed-status-2> element) is a child of the within the art known <tuple> element and must preferably not appear as a child of a PIDF <status> element or another <timed-status> or <timed-status-2> element. More than one such element may appear within a PIDF <tuple> element.

Sources of <timed-status-2> information should avoid elements that overlap in time, but since overlapping appointments are common in calendars, for example, receivers (the watchers) must be able to render such overlapping <timed-status-2> indications.

The <timed-status-2> element must be qualified with the ‘from’ attribute and may be qualified with an ‘until’ attribute to describe the time when the status assumed this value and the time until which this element is expected to be valid. If the ‘until’ attribute is missing, the information is assumed valid until the tuple is explicitly overridden or expires as defined by the publication mechanism used. The time range may encompass the present time, i.e., the PIDF <timestamp> value, which provides for an improved way of managing presence information. Thus, the ‘from’ attribute for tuples without an ‘until’ attribute most not necessarily refer to the future. Alternatively, the time range may not encompass the present time.

The <timed-status-2> element may contain the <basic> and <note> elements, as well as any other element that is appropriate as a PIDF <status> extension and that has a limited validity period. Examples include the PIDF-LO (see request for Comment no. 4119 issued by the Network Working Group and on Sep. 22, 2008 available on http://www.ietf.org/rfc/rfc4119.txt) extensions for location objects.

This extension has absolute rather than relative times, since relative times would be too hard to keep properly updated when spacing notifications, for example. Originators of presence information must not necessarily generate time values in the <timed-status-2> elements that are fully in the past or future relative to local real (wallclock) time and the time information contained in the optional PIDF <timestamp> element.

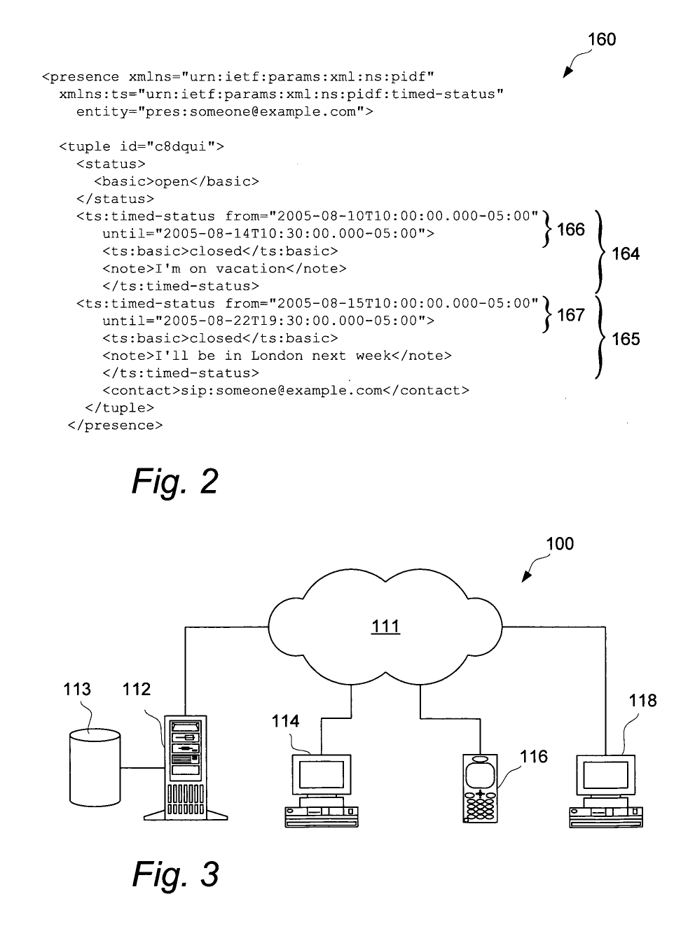

An example combining PIDF and a first and a second timed-status element is shown by the data structure 160 in FIG. 2, where the first timed-status is indicated by the reference numeral 164 while the second timed-status is indicated by the reference numeral 165. As can be seen, in this case T11 is 2005-08-10T10:00:00.000-05:00 and T12 is 2005-08-14T10:30:00.000-05:00, as indicated by reference numeral 166, while T21 is 2005-08-15T10:00:00.000-05:00 and T22 is 2005-08-22T19:30:00.000-05:00, as indicated by reference numeral 167. In this case the first timed status 164 is associated with one note (I'm on vacation) while the second timed status 165 is associated with another note (I'll be in London next week). As may be seen in FIG. 2, one contact address (someone@example.com) is used for both the first and the second time intervals r1 and r2.

Returning now to FIG. 1, when then method is executed, the client 114 sends 131 a presence document 120 to the presence server 112. The presence document 120 comprises the first and the second time intervals τ1 and τ2, and the client 114 is associated with a presentity 100 that sets the time intervals τ1, τ2 according to his availability.

The presence server 112 sends 132 the presence document 120 to a client watcher 116 subscribing to the presence of the presentity 100. The presence server 112 preferably ensures 127 that the real time T (clock-time) is smaller than T11 and T21. When the watcher client 116 receives the presence document 120 it updates 134 the representation of the presence of the presentity 100, such that a person at the watcher client 116 may view the presence.

When the client watcher 116 first connects to the presence server 112, the client watcher 116 sends 136 a message 126 indicating that it is able to read presence documents with two time intervals specified by the above described first <timed-status> element and second <timed-status-2> element.

In case a watcher client 118 is not capable of reading a time value of a second <timed-status-2> element, the presence server 112 creates two presence documents 128, 129 each comprising a respective time interval τ1, τ2. In this case it is also ensured 128, 129 that the real time T is smaller than T11 and T21 when the corresponding time interval is sent out 137, 138.

When the watcher client 118 receives any of the presence documents 122, 124 it updates 135 the representation of the presence of the presentity 100, such that a person at the watcher client 118 may view the presence.

Of course, a huge number of presence clients and watcher clients may be connected to the presence server 112, and a presence client may act as a watcher client and vice versa.

The skilled person also realizes that the invention may be implemented on any hardware platform configured to manage presences of presentities and allow watchers to subscribe to the presences. However, to exemplify and as illustrated in FIG. 2, a presence management system typically comprises a conventional computer server 112 that is connected to a database 113 that stores information of presentities's presence. A number of presence clients 114, 116, 118, which clients also acts as watchers, are connected to the presence server 112 via a network 111 such as the Internet. A presence/watcher client may, for example, be a cell phone, a computer, a PDA or a media player.

The presence data format may also be specified in accordance with the standards of OMA (Open Mobile Alliance) Presence and Availability Working Group which largely builds on the work done in the IETF SIMPLE Working Group (SIP for Instant Messaging and Presence Leveraging Extensions). Accordingly, the invention may readily be implemented by using other formats than the specifically described Presence Information Data Format.

Although various embodiments of the present invention have been described and shown, the invention is not restricted thereto, but may also be embodied in other ways within the scope of the subject-matter defined in the following claims.

1. A method of managing presence information for a presentity (100), the method comprising the steps of:
sending (130) a presence document (120) from a client (114) to a presence server (112), the document (120) comprising a first time interval (τ1) indicating a first presence state associated with the presentity (100) and comprising a second time interval (τ2) indicating a second presence state associated with the presentity (100),
sending (132) the presence document (120) from the presence server (112) to a watching client (116), and
updating (134), at the watching client (116), the representation of the first presence state and the representation of the second presence state.

2. A method according to claim 1, wherein the step of sending (132) the presence document (120) to the watching client (116) comprises sending the presence document to the watching client (116) before time (T) falls within any of the time intervals (τ1, τ2).

3. A method according to claim 1 or 2, wherein the step of updating (134) the representation of the presence states comprises updating the representation of any of the first and the second presence state before time (T) falls within the time interval (τ1; τ2) of the presence state to be updated.

4. A method according to any one of claims 1-3, wherein the first time interval (τ1) is different from the second (τ2) time interval.

5. A method according to any one of claims 1-4, further comprising the step of scheduling sending of a plurality of presence documents from the presence server (112), in dependence of the amount of presence documents to be sent by the presence server (112).

6. A method according to any one of claims 1-5, further comprising the step of sending (136), from the watching client (114) to the presence server (112), a message (126) indicative of the watching clients (116) capability of updating (134) the representation of the first and second presence states by retrieving said presence states from the presence document (120).

7. A method according to any one of claims 1-6, further comprising the step of sending (137, 138), from the presence server (112) to a watching client (118) not capable of updating (135) the representation of the first and second presence states by retrieving said presence states from the presence document (120), a presence document (122; 124) comprising only one of said time intervals (τ1; τ2) and corresponding presence state.

8. A method according to any one of claims 1-7, further comprising defining a time value (T3) indicating when the presence document (120) may be sent (132) from the presence server (112) to the watching client (116).

9. A method according to any one of claims 1-8, wherein the presence document (120) is represented by a data structure (160) comprising at least two entities (164, 165) representing the first time interval (166) and the second time interval (167).

10. A system for managing presence information for a presentity (100), the system being configured to:
send (130) a presence document (120) from a client (114) to a presence server (112), the document (120) comprising a first time interval (τ1) indicating a first presence state associated with the presentity (100) and comprising a second time interval (τ2) indicating a second presence state associated with the presentity (100),
send (132) the presence document (120) from the presence server (112) to a watching client (116), and
update (134), at the watching client (116), the representation of the first presence state and the representation of the second presence state.

11. A system according to claim 10, wherein the system is configured to send (132) the presence document (120) from the presence server (112) to the watching client (116) before time (T) falls within any of the time intervals (τ1, τ2).

12. A system according to claim 10 or 11, wherein the system is configured to update (134) the representation of any of the first and the second presence state before time (T) falls within the time interval (τ1; τ2) of the presence state to be updated.

13. A system according to any one of claims 10-12, wherein the first time interval (τ1) is different from the second (τ2) time interval.

14. A system according to any one of claims 10-13, wherein the system is configured to schedule sending of a plurality of presence documents from the presence server (112), in dependence of the amount of presence documents to be sent by the presence server (112).

15. A system according to any one of claims 10-14, wherein the system is configured to send (136), from the watching client (114) to the presence server (112), a message (126) indicative of the watching clients (116) capability of updating (134) the representation of the first and second presence states by retrieving said presence states from the presence document (120).

16. A system according to any one of claims 10-15, wherein the system is configured to send (137, 138), from the presence server (112) to a watching client (118) not capable of updating (135) the representation of the first and second presence states by retrieving said presence states from the presence document (120), a presence document (122; 124) comprising only one of said time intervals (τ1; τ2) and corresponding presence state.

17. A system according to any one of claims 10-16, wherein the system is configured to define a time value (T3) indicating when the presence document (120) may be sent (132) from the presence server (112) to the watching client (116).

18. A system according to any one of claims 10-17, wherein the presence document (120) is represented by a data structure (160) comprising at least two entities (164, 165) representing the first time interval (166) and the second time interval (167).

19. A presence server for managing presence information for a presentity (100), the presence server (112) being configured to:
receive (130) a presence document (120) from a client (114), the document (120) comprising a first time interval (τ1) indicating a first presence state associated with the presentity (100) and comprising a second time interval (τ2) indicating a second presence state associated with the presentity (100),
send (132) the presence document (120) to a watching client (116), for allowing the watching client (116) to update the representation of the first presence state and the representation of the second presence state.

20. A presentity client for managing presence information for a presentity (100), the client (114) being configured to:
send (130) a presence document (120) to a presence server (112), the document (120) comprising a first time interval (τ1) indicating a first presence state associated with the presentity (100) and comprising a second time interval (τ2) indicating a second presence state associated with the presentity (100),
for allowing the presence server (112) to send the presence document (120) to a watching client (116) and thereby allow the watching client (116) to update (134) its representation of the first presence state and the representation of the second presence state.

21. A watcher client for displaying presence information for a presentity (100), the watcher (118) being configured to:
receive (132) a presence document (120) from a presence server (112), the presence document being previously sent from a client (114) to the presence server (112), the document (120) comprising a first time interval (τ1) indicating a first presence state associated with the presentity (100) and comprising a second time interval (τ2) indicating a second presence state associated with the presentity (100), and
update (134) the representation of a first presence state and the representation of a second presence state, such that the presence states may be viewed at the watcher.

22. A computer readable medium having stored thereon software instructions for performing a method according to any one of claims 1-9, when executed in a network environment.
